(19) United States
(12) Patent Application Publication
(10) Pub. No.: US 2018/0239436 A1
(43) Pub. Date: Aug. 23, 2018

(54) GESTURE RECOGNITION DEVICE AND MAN-MACHINE INTERACTION SYSTEM

(71) Applicant: HON HAI PRECISION INDUSTRY CO., LTD., New Taipei (TW)

(72) Inventor: CHUNG-CHE WEI, New Taipei (TW)

(21) Appl. No.: 15/795,554

(22) Filed: Oct. 27, 2017

(30) Foreign Application Priority Data
Feb. 17, 2017 (TW) 106105231

(51) Int. Cl. G06F 3/01; G06K 9/00; G06T 7/50

(52) U.S. Cl. CPC G06F 3/017; G06K 9/00355; G06N 3/02; G06K 9/00201; G06T 7/50; G06K 9/00389

(57) ABSTRACT

A gesture recognition device is related. The gesture recognition device includes a controlling module, a gesture detecting module configured to detect the position of the hand to obtain the data of the hand position, a calculating module configured to calculate the data of the hand position, a recognizing module configured to recognize the gesture, and a communication module. The gesture detecting module includes a 3-dimensional (3D) sensor for hand motion capture. A man-machine interaction system using the gesture recognition device is also related.

### CROSS-REFERENCE TO RELATED APPLICATIONS

This application claims all benefits accruing under 35 U.S.C. §119 from Taiwan Patent Application No. 106105231, filed on Feb. 17, 2017, in the Taiwan Intellectual Property Office, the contents of which are hereby incorporated by reference.

### BACKGROUND

### 1. Technical Field

The present disclosure relates to gesture recognition devices and man-machine interaction systems using the same.

### 2. Description of Related Art

Machine learning evolves the study of pattern recognition and computational learning theory in artificial intelligence. A branch of machine learning, called deep learning, is based on a set of algorithms that attempt to model high-level abstractions in data by using a deep graph with multiple processing layers. The deep learning is composed of multiple linear and non-linear transformations. With the exponential growth of technological advancements, deep learning is used everywhere, including cloud computing, medicine, media, security and autonomous vehicles.

Aside from artificial intelligence, virtual reality and augmented reality are another area that is currently blooming in the technological field. They allow users to interact with non-existing items that are only present in the mind of the machines. A common issue that developers face is the different type of ways that allow user to interact with the virtual objects. The simplest and most traditional option is to use actual peripherals, such as the gaming controllers utilized by HTC Vive and Oculus Rift. Although accurate and precise, using physical actuators would deeply deteriorate the immersive experience that virtual realities are hoping to achieve.

Alternatively, voice activation commands can be employed, although not without its drawbacks. First, to accommodate all languages in the world, one simple command may need to be implemented into at least ten different pronunciations. It is also incredibly difficult to accurately interpret spoken words, varying factors such as pitch, accent and rhythm could all contribute and affect the machine's ability to output the correct result. Lastly, any surrounding noise would greatly lower the chance to accurately interpret the spoken words. The proposed method, virtual/augmented reality hand input recognition through machine learning, allows users to communicate with the machine in both virtual and augmented reality without the need to interact with any physical devices. The man-machine interaction system usually uses an ordinary camera for hand images capture, a first neural network for positioning a hand, and a second neural network for 2-dimensional (2D) recognition of the hand's motions. However, the man-machine interaction system is complicated and has poor efficiency because two different neural networks are used.

What is needed, therefore, is to provide a gesture recognition device and man-machine interaction system that can overcome the problems as discussed above.

### BRIEF DESCRIPTION OF THE DRAWINGS

Many aspects of the exemplary embodiments can be better understood with reference to the following drawings. The components in the drawings are not necessarily drawn to scale, the emphasis instead being placed upon clearly illustrating the principles of the exemplary embodiments. Moreover, in the drawings, like reference numerals designate corresponding parts throughout the several views.

FIG. 1 is a functional diagram of one exemplary embodiment of a man-machine interaction system.

FIG. 2 shows a functional diagram of example 1 of a gesture recognition device.

FIG. 3 is a flow chart of the gesture recognition device in the example 1.

FIG. 4 is a flow chart for determining whether a gesture is a 2D gesture of the gesture recognition device in the example 1.

FIG. 5 shows a schematic diagram of a depth direction in example 1.

FIG. 6 shows a functional diagram of example 2 of a gesture recognition device.

FIG. 7 shows two different gestures in example 2.

FIG. 8 is a flow chart of the gesture recognition device in the example 2.

FIG. 9 is another flow chart of the gesture recognition device in the example 2.

FIG. 10 shows a functional diagram of example 3 of a gesture recognition device.

FIG. 11 shows two different gestures in example 3.

FIG. 12 is a flow chart of the gesture recognition device in the example 3.

FIG. 13 is another flow chart of the gesture recognition device in the example 3.

FIG. 14 shows a functional diagram of example 4 of a gesture recognition device.

FIG. 15 shows two different gestures in example 4.

FIG. 16 is a flow chart of the gesture recognition device in the example 4.

FIG. 17 is another flow chart of the gesture recognition device in the example 4.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the exemplary embodiments described herein. However, it will be understood by those of ordinary skill in the art that the exemplary embodiments described herein can be practiced without these specific details. In other instances, methods, procedures, and components have not been described in detail so as not to obscure the related relevant feature being described. The drawings are not necessarily to scale, and the proportions of certain parts may be exaggerated better illustrate details and features. The description is not to considered as limiting the scope of the exemplary embodiments described herein.

Several definitions that apply throughout this disclosure will now be presented. The terms “connected” and “coupled” are defined as connected, whether directly or indirectly through intervening components, and is not necessarily limited to physical connections. The connection can be such that the objects are permanently connected or releasably connected. The term “outside” refers to a region that is beyond the outermost confines of a physical object. The term “inside” indicates that at least a portion of a region is partially contained within a boundary formed by the object. The term “substantially” is defined to essentially conforming to the particular dimension, shape or other word that substantially modifies, such that the component need not be exact. For example, substantially cylindrical means that the object resembles a cylinder, but can have one or more deviations from a true cylinder. The term “comprising” means “including, but not necessarily limited to”; it specifically indicates open-ended inclusion or membership in a so-described combination, group, series and the like. It should be noted that references to “an” or “one” exemplary embodiment in this disclosure are not necessarily to the same exemplary embodiment, and such references mean at least one.

In general, the word “module,” as used herein, refers to logic embodied in hardware or firmware, or to a collection of software instructions, written in a programming language, such as, for example, Java, C, or assembly. One or more software instructions in the modules may be embedded in firmware, such as an EPROM. It will be appreciated that modules may include connected logic units, such as gates and flip-flops, and may include programmable units, such as programmable gate arrays or processors. The modules described herein may be implemented as either software and/or hardware modules and may be stored in any type of computer-readable medium or other computer storage device.

References will now be made to the drawings to describe, in detail, various exemplary embodiments of the present gesture recognition devices and man-machine interaction systems using the same.

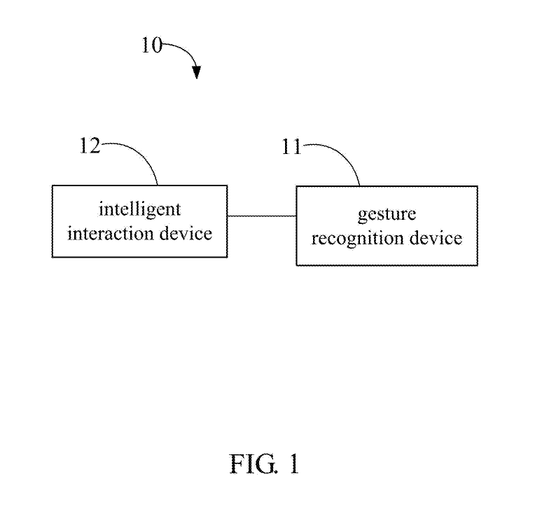

Referring to FIG. 1, a man-machine interaction system 10 of one exemplary embodiment includes a gesture recognition device 11 and an intelligent interaction device 12 connected to the gesture recognition device 11. The intelligent interaction device 12 can be connected to the gesture recognition device 11 by wires or wireless. The gesture recognition device 11 recognizes the gesture of the user and sends the recognition results to the intelligent interaction device 12, and the intelligent interaction device 12 interacts with the user according to the recognition results.

The intelligent interaction device 12 can be a game engine unity, a virtual reality device, or an augmented reality device. The intelligent interaction device 12 can include image acquisition sensors and sound acquisition sensors.

Different examples of the gesture recognition device 11 are described as below.

### EXAMPLE 1

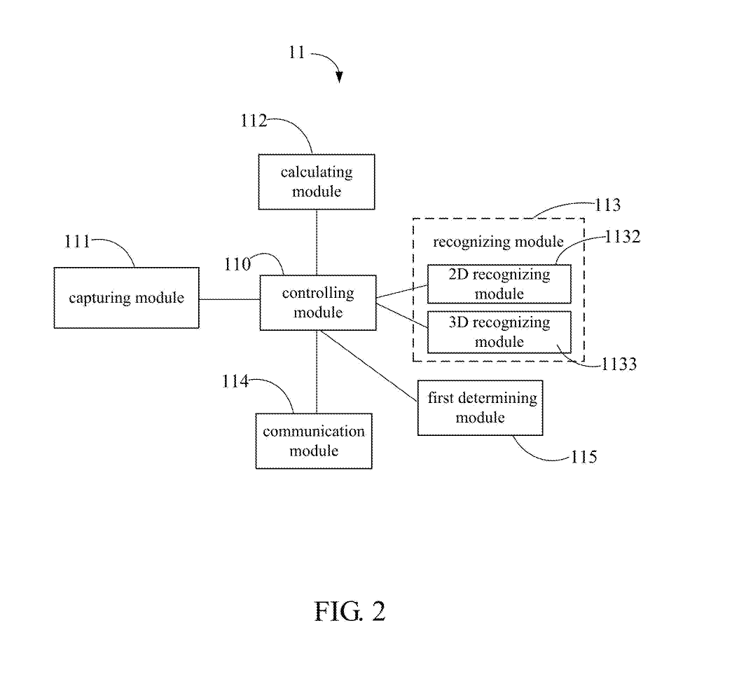

Referring to FIG. 2, the gesture recognition device 11 of example 1 includes a controlling module 110, a capturing module 111, a calculating module 112, a recognizing module 113, and a communication module 114. The capturing module 111, the calculating module 112, the recognizing module 113, and the communication module 114 are respectively connected to the controlling module 110 by wires or wireless.

The controlling module 110 controls the operation of the gesture recognition device 11. The capturing module 111 detects the position of a hand to obtain the hand's positional data. The calculating module 112 calculates a distance between two positions of the hand according to the hand's positional data. The recognizing module 113 recognizes the gesture according to the hand's positional data. The communication module 114 communicates with the intelligent interaction device 12. The gesture recognition device 11 can further includes a storage module (not shown) for storing data.

The capturing module 111 includes a 3-dimensional (3D) sensor for hand motion capture. The 3D sensor can be an infrared sensor, a laser sensor, or an ultrasonic sensor. In one exemplary embodiment, the 3D sensor is a LEAP MOTION®. The LEAP MOTION® is a hand motion sensing device that is able to capture and output the position of both hands through USB 3.0. The gesture recognition device 11 does not need a special neural network for recognizing the hand position from the image. The gesture recognition device 11 is simple and highly efficient.

In one exemplary embodiment, the gesture recognition device 11 further includes a first determining module 115. The first determining module 115 determines whether the gesture of the user is 2-dimensional (2D) gesture. The recognizing module 113 includes a 2D recognizing module 1132 and a 3D recognizing module 1133. The 2D recognizing module 1132 only recognizes the 2D gesture, and the 3D recognizing module 1133 only recognizes the 3D gesture. Thus, the gesture recognition device 11 has a high recognition efficiency.

The 2D recognizing module 1132 includes a 2D recognizing neural network specially used for recognizing 2D gesture. The 3D recognizing module 1133 includes a 3D recognizing neural network specially used for recognizing 3D gesture. Both the 2D recognizing neural network and the 3D recognizing neural network are essentially the same, in terms of converting the user inputs into the input layer of the neural networks. The 3D recognizing neural network is used to recognize a complicated gesture and cost more time than the 2D recognizing neural network. For 2D recognizing neural network, the number of input pixels (hand positions) will be width×height, whereas 3D recognizing neural network will be width×height×depth. Both the 2D recognizing neural network and the 3D recognizing neural network can be a deep learning network, such as a convolutional neural network or recurrent neural network. Through proper training with forward and backward propagation, a satisfied output will be computed by the trained network.

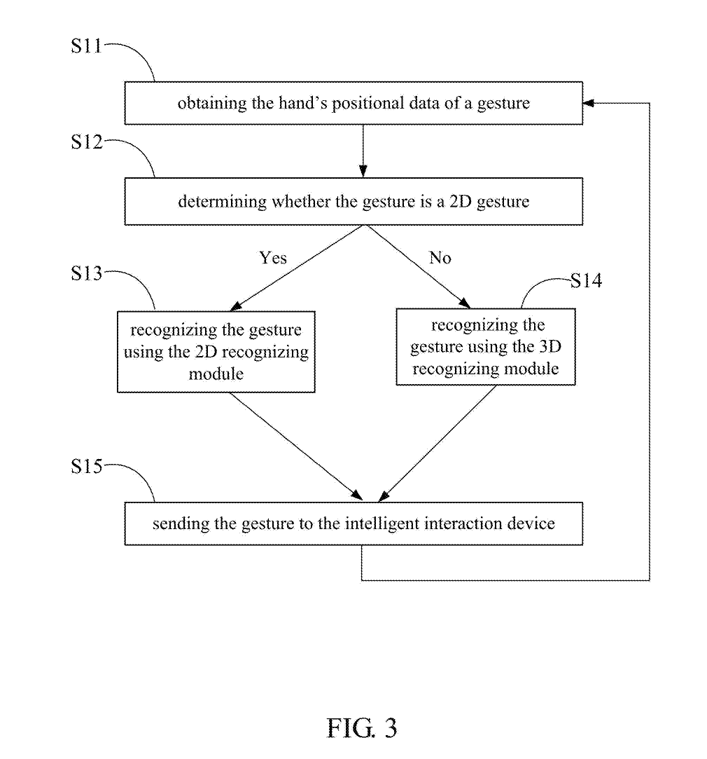

Referring to FIG. 3, in one exemplary embodiment, the operation method of the gesture recognition device 11 includes following steps:

step S11, obtaining the hand's positional data of a gesture, proceeding to step S12;

step S12, determining whether the gesture is a 2D gesture, if yes, proceeding to step S13, if no, proceeding to step S14;

step S13, recognizing the gesture using the 2D recognizing module 1132, proceeding to step S15;

step S14, recognizing the gesture using the 3D recognizing module 1133, proceeding to step S15; and

step S15, sending the gesture to the intelligent interaction device 12, return to step S11.

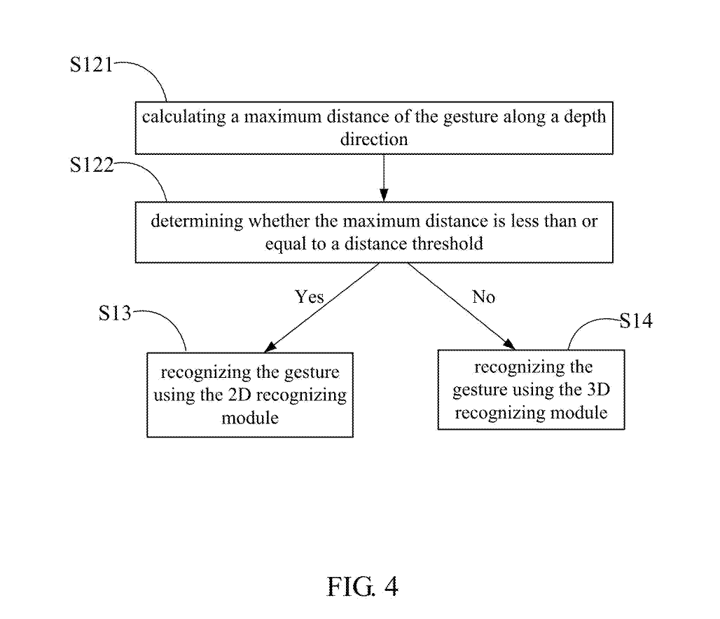

Referring to FIG. 4, in step S12, the determining whether the gesture is the 2D gesture includes:

step S121, calculating a maximum distance of the gesture along a depth direction; and

step S122, determining whether the maximum distance is less than or equal to a distance threshold, if yes, proceeding to step S13, if no, proceeding to step S14.

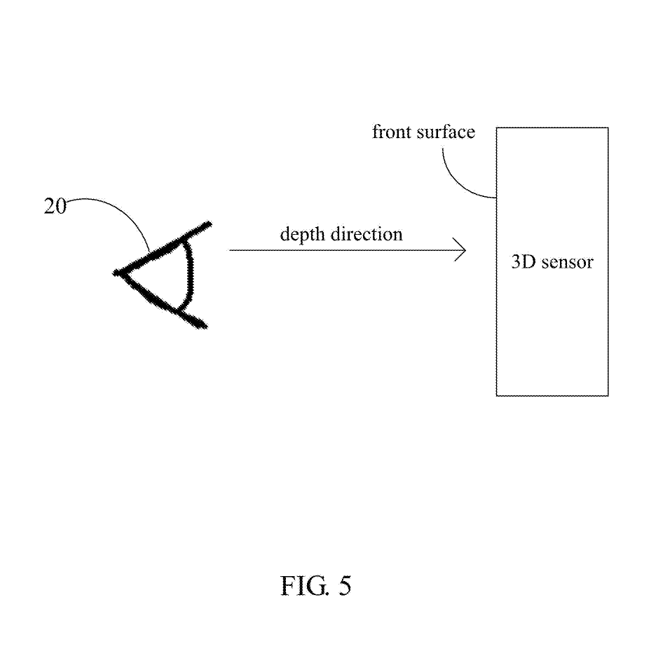

In step S121, the direction, that is perpendicular the front surface of the 3D sensor, is defined as the depth direction as shown in FIG. 5. When the 3D sensor is used, the user 20 is in front of the 3D sensor and faces the 3D sensor. The depth direction is parallel to the viewing direction of the user 20.

In step S122, the distance threshold can be selected according to need or experience. In one exemplary embodiment, the distance threshold can be in a range of about 2 centimeters to about 5 centimeters. When the maximum distance is less than or equal to the distance threshold, 2D gesture is determined as a result. When the maximum distance is greater than the distance threshold, 3D gesture is determined as a result.

In testing, a 3-layered neural network with 30 hidden neurons has been implemented to test MNIST hand written digit data with an accuracy of up to 95%. Pinch draw using Leap Motion in Unity is also successful.

### EXAMPLE 2

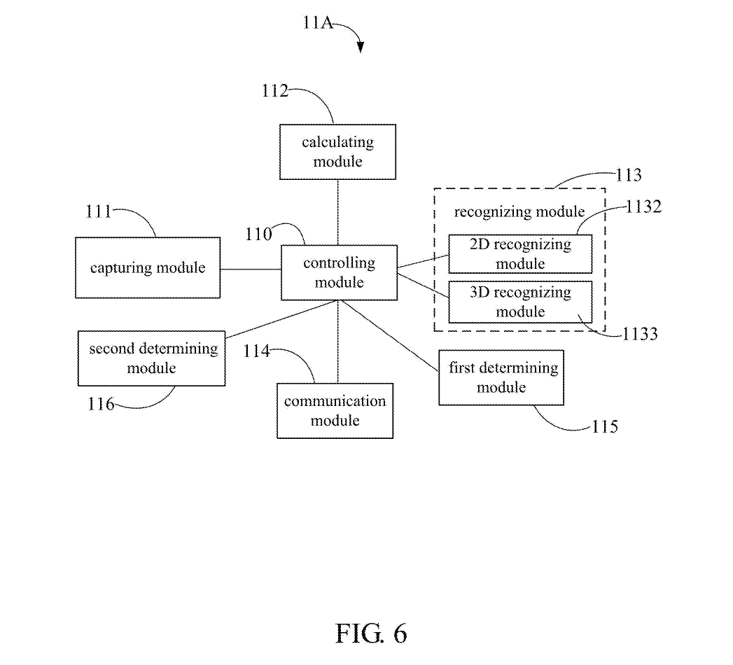

Referring to FIG. 6, the gesture recognition device 11A of example 2 includes a controlling module 110, a capturing module 111, a calculating module 112, a recognizing module 113, a communication module 114, a first determining module 115, and a second determining module 116.

The gesture recognition device 11A of example 2 is similar to gesture recognition device 11 of example 1 except that the gesture recognition device 11A further include the second determining module 116. The second determining module 116 determines whether an initiation command or an end command is received.

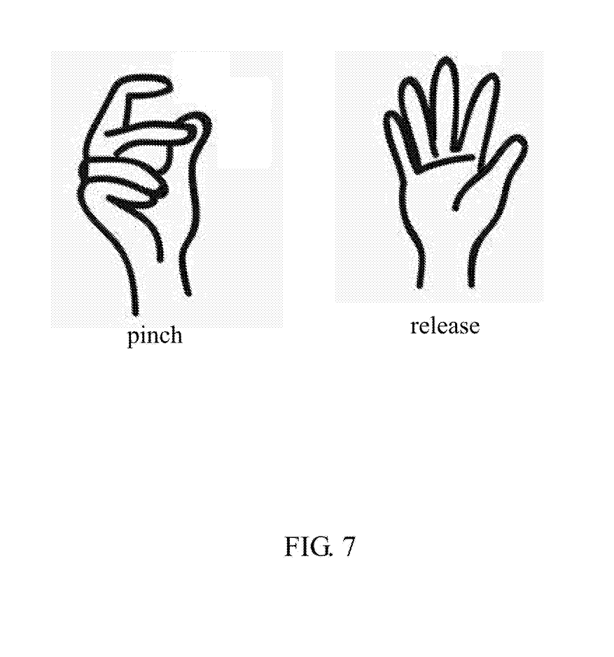

The initiation command and the end command can be electromagnetic signals from other device, such as mobile phone of user, and received by the communication module 114. The initiation command and the end command can also be a gesture performed by user and recognized by the recognizing module 113. As shown in FIG. 7, in one exemplary embodiment, a pinch action is defined as the initiation command, and a release action is defined as the end command. The obtaining the hand's positional data can be initiated by actions such as performing a pinch action, and ends when the fingers are released from pinched state.

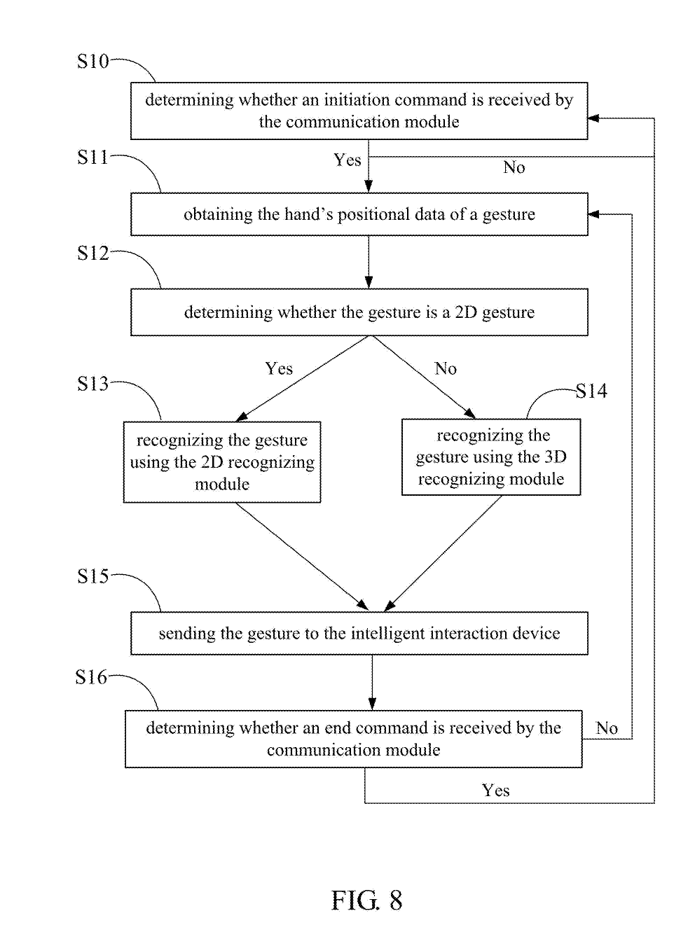

Referring to FIG. 8, in one exemplary embodiment, when the initiation command and the end command are electromagnetic signals received by the communication module 114, the operation method of the gesture recognition device 11A includes following steps:

step S10, determining whether an initiation command is received by the communication module 114, if yes, proceeding to step S11, if no, repeating step S10;

step S11, obtaining the hand's positional data of a gesture, proceeding to step S12;

step S12, determining whether the gesture is a 2D gesture, if yes, proceeding to step S13, if no, proceeding to step S14;

step S13, recognizing the gesture using the 2D recognizing module 1132, proceeding to step S15;

step S14, recognizing the gesture using the 3D recognizing module 1133, proceeding to step S15;

step S15, sending the gesture to the intelligent interaction device 12, proceeding to step S16; and

step S16, determining whether an end command is received by the communication module 114 with in a time threshold, if yes, return to step S10, if no, return to step S11.

In step S16, the time threshold can be selected according to need or experience. In one exemplary embodiment, the time threshold can be in a range of about 2 seconds to about 5 seconds.

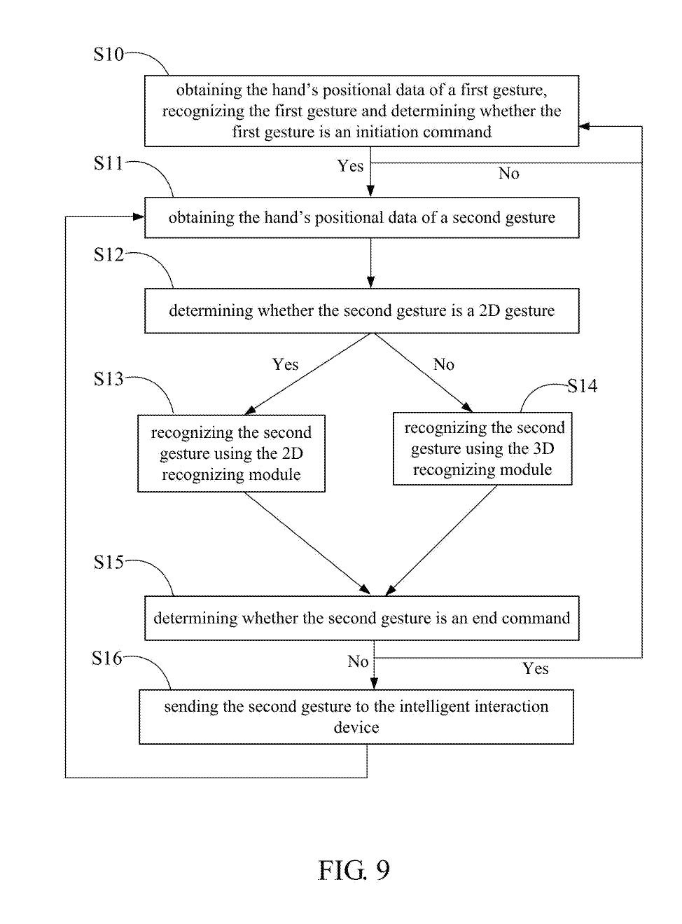

Referring to FIG. 9, in another exemplary embodiment, when the initiation command and the end command are gestures performed by user and recognized by the recognizing module 113, the operation method of the gesture recognition device 11A includes following steps:

step S10, obtaining the hand's positional data of a first gesture, recognizing the first gesture and determining whether the first gesture is an initiation command, if yes, proceeding to step S11, if no, repeating step S10;

step S11, obtaining the hand's positional data of a second gesture, proceeding to step S12;

step S12, determining whether the second gesture is a 2D gesture, if yes, proceeding to step S13, if no, proceeding to step S14;

step S13, recognizing the second gesture using the 2D recognizing module 1132, proceeding to step S15;

step S14, recognizing the second gesture using the 3D recognizing module 1133, proceeding to step S15;

step S15, determining whether the second gesture is an end command, if yes, return to step S10, if no, proceeding to step S16; and

step S16, sending the second gesture to the intelligent interaction device 12, return to step S11.

In step S10, a first standard gesture is defined as the initiation command. When the first standard gesture is a 2D gesture, the first gesture is recognized directly by the 2D recognizing module 1132 and then compared with the first standard gesture by the second determining module 116. When the first standard gesture is a 3D gesture, the first gesture is recognized directly by the 3D recognizing module 1133 and then compared with the first standard gesture by the second determining module 116. When the first gesture is the same as the first standard gesture, the first gesture is determined to be the initiation command.

In step S15, a second standard gesture is defined as the end command, and the second gesture is compared with the second standard gesture by the second determining module 116. When the second gesture is the same as the second standard gesture, the second gesture is determined to be the end command.

### EXAMPLE 3

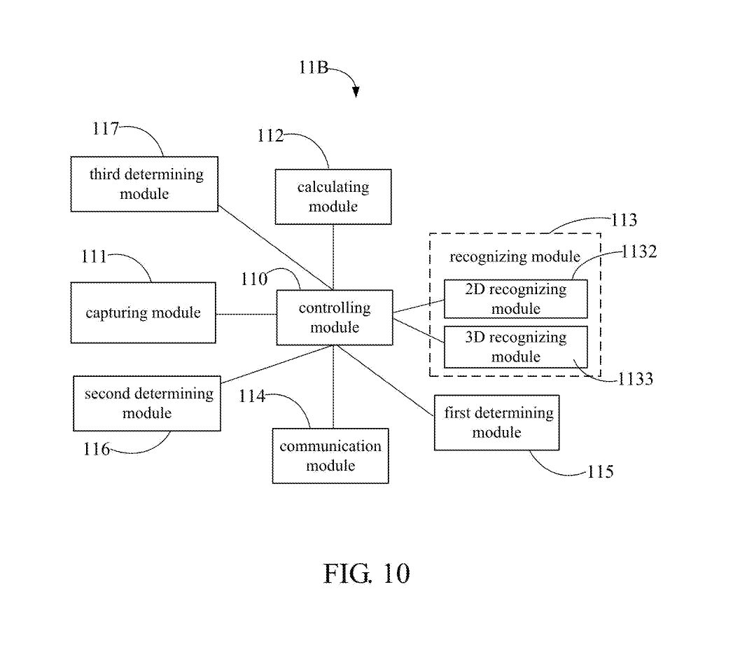

Referring to FIG. 10, the gesture recognition device 11B of example 3 includes a controlling module 110, a capturing module 111, a calculating module 112, a recognizing module 113, a communication module 114, a first determining module 115, a second determining module 116, and a third determining module 117.

The gesture recognition device 11B of example 3 is similar to gesture recognition device 11A of example 2 except that the gesture recognition device 11B further includes the third determining module 117. The third determining module 117 determines whether a selecting command is received. The selecting command selects one of the 2D recognizing module 1132 and the 3D recognizing module 1133 as a selected recognizing module.

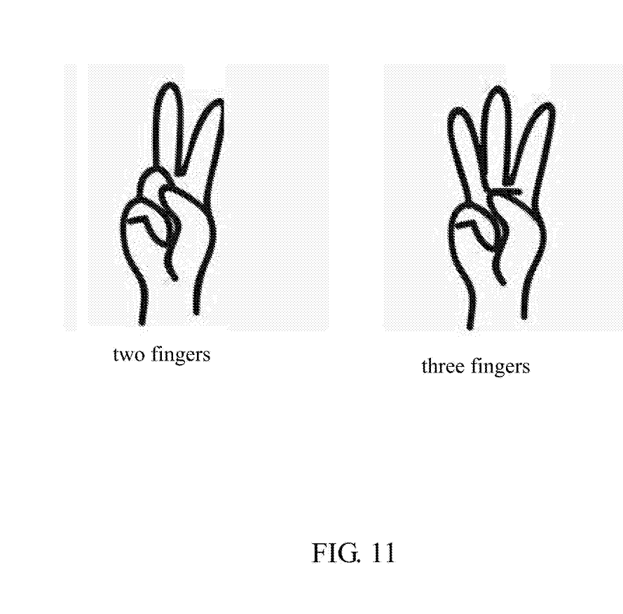

The selecting command can be electromagnetic signals from other device, such as mobile phone of user, and received by the communication module 114. The selecting command can also be gesture performed by user and recognized by the recognizing module 113. As shown in FIG. 11, in one exemplary embodiment, a gesture of extending only two fingers, such as the index finger and the middle finger, is defined as selecting the 2D recognizing module 1132; and a gesture of extending only three fingers, such as the index finger, the middle finger, and the ring finger, is defined as selecting the 3D recognizing module 1133.

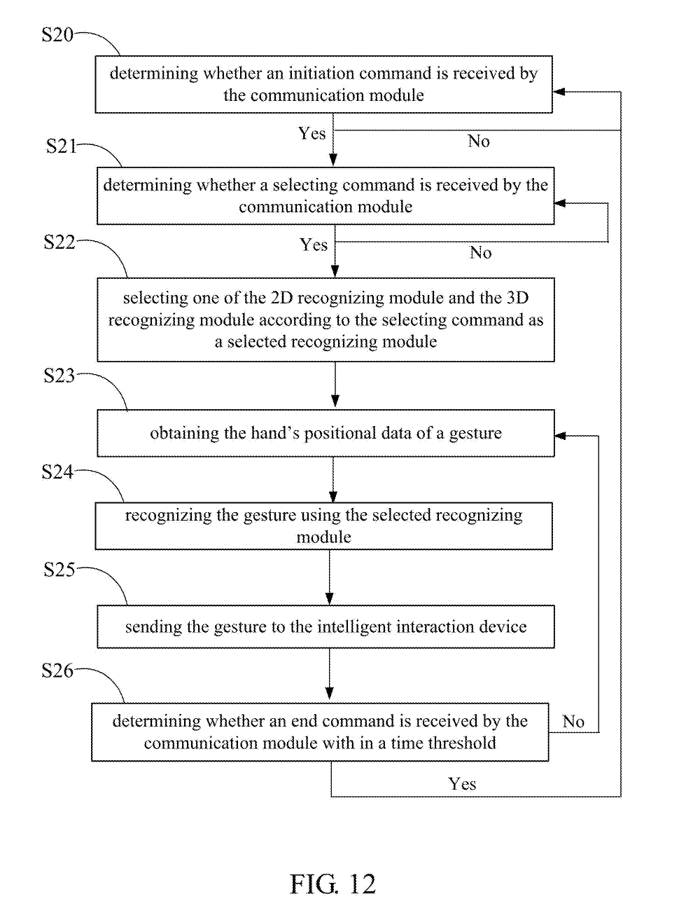

Referring to FIG. 12, in one exemplary embodiment, when the selecting command is electromagnetic signals received by the communication module 114, the operation method of the gesture recognition device 11B includes following steps:

step S20, determining whether an initiation command is received by the communication module 114, if yes, proceeding to step S21, if no, repeating step S20;

step S21, determining whether a selecting command is received by the communication module 114, if yes, proceeding to step S22, if no, repeating step S21;

step S22, selecting one of the 2D recognizing module 1132 and the 3D recognizing module 1133 according to the selecting command as a selected recognizing module, proceeding to step S23;

step S23, obtaining the hand's positional data of a gesture, proceeding to step S24;

step S24, recognizing the gesture using the selected recognizing module, proceeding to step S25;

step S25, sending the gesture to the intelligent interaction device 12, proceeding to step S26; and

step S26, determining whether an end command is received by the communication module 114 with in a time threshold, if yes, return to step S20, if no, return to step S23.

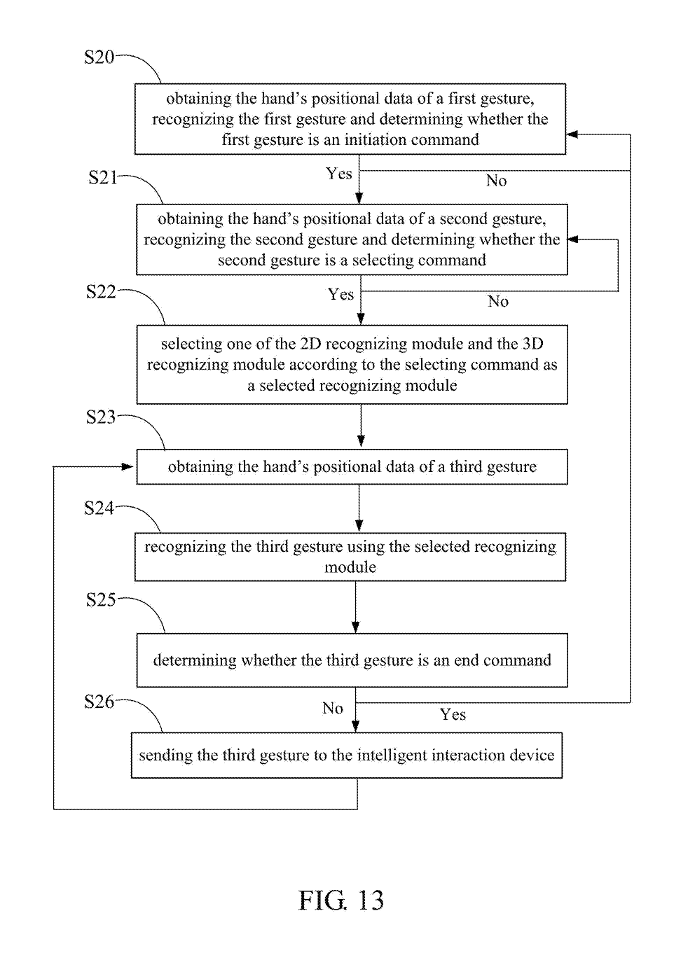

Referring to FIG. 13, in another exemplary embodiment, when the selecting command is a gesture performed by user and recognized by the recognizing module 113, the operation method of the gesture recognition device 11B includes following steps:

step S20, obtaining the hand's positional data of a first gesture, recognizing the first gesture and determining whether the first gesture is an initiation command, if yes, proceeding to step S21, if no, repeating step S20;

step S21, obtaining the hand's positional data of a second gesture, recognizing the second gesture and determining whether the second gesture is a selecting command, if yes, proceeding to step S22, if no, repeating step S21;

step S22, selecting one of the 2D recognizing module 1132 and the 3D recognizing module 1133 according to the selecting command as a selected recognizing module, proceeding to step S23;

step S23, obtaining the hand's positional data of a third gesture, proceeding to step S24;

step S24, recognizing the third gesture using the selected recognizing module, proceeding to step S25;

step S25, determining whether the third gesture is an end command, if yes, return to step S20, if no, proceeding to step S26; and

step S26, sending the third gesture to the intelligent interaction device 12, return to step S23.

In step S21, when a third standard gesture is defined as the selecting command, and the second gesture is compared with the third standard gesture by the third determining module 117. When the second gesture is the same as the third standard gesture, the second gesture is determined to be the selecting command.

### EXAMPLE 4

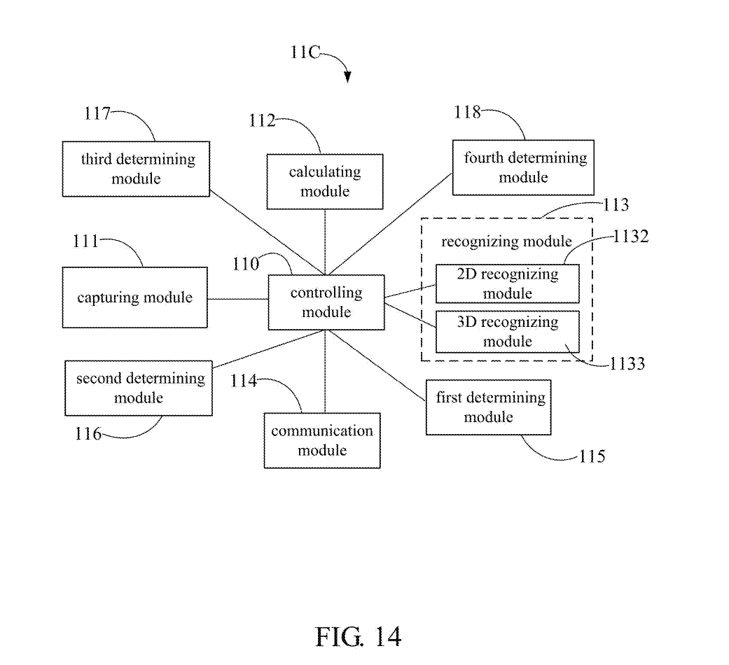

Referring to FIG. 14, the gesture recognition device 11C of example 4 includes a controlling module 110, a capturing module 111, a calculating module 112, a recognizing module 113, a communication module 114, a first determining module 115, a second determining module 116, a third determining module 117, and a fourth determining module 118.

The gesture recognition device 11C of example 4 is similar to gesture recognition device 11B of example 3 except that the gesture recognition device 11C further include the fourth determining module 118. The fourth determining module 118 determines whether a switching command is received. The switching command switches the selected recognizing module between the 2D recognizing module 1132 and the 3D recognizing module 1133.

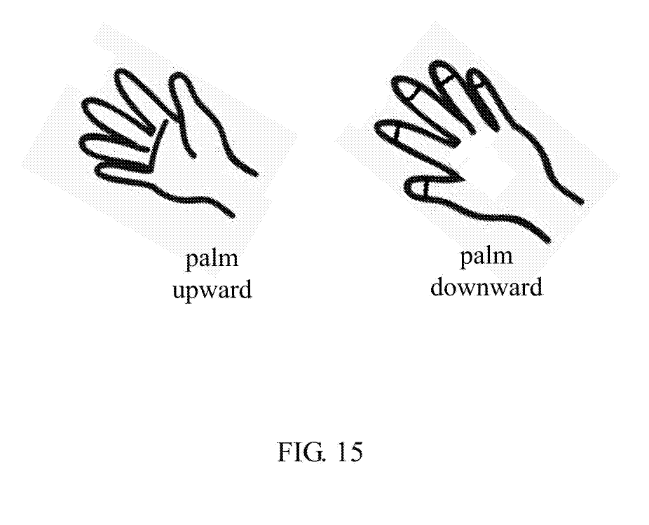

The switching command can be electromagnetic signals from other device, such as mobile phone of user, and received by the communication module 114. The switching command can also be a gesture performed by user and recognized by the recognizing module 113. As shown in FIG. 15, in one exemplary embodiment, a reversion between the palm upward and palm downward is defined as the switching command. When the reversion between the palm upward and palm downward is performed for one time, the selected recognizing module would be switched for one time between the 2D recognizing module 1132 and the 3D recognizing module 1133.

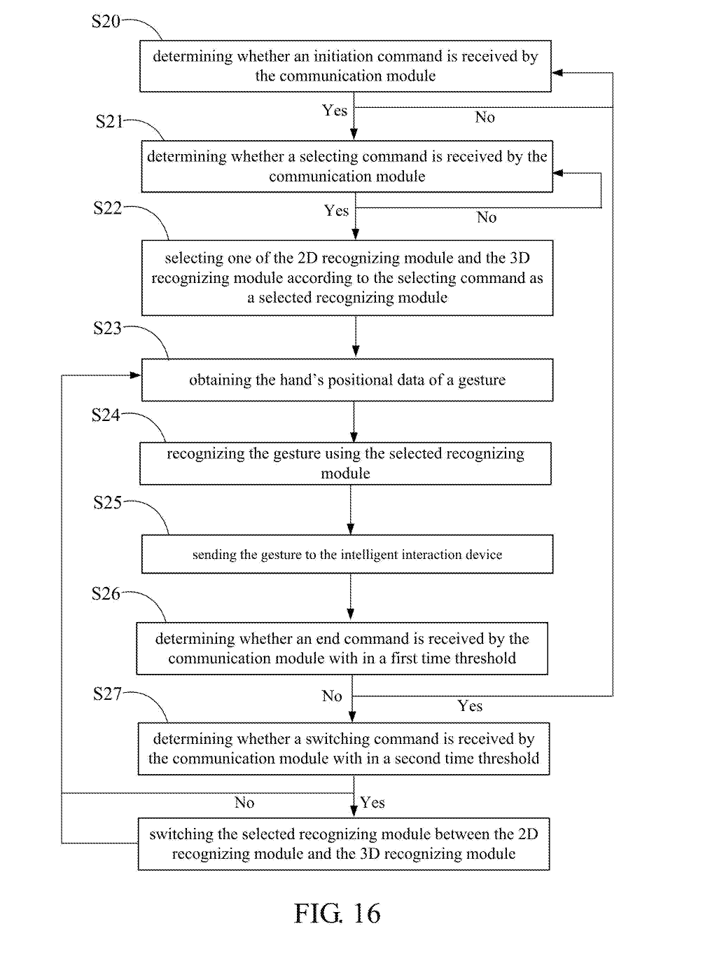

Referring to FIG. 16, in one exemplary embodiment, when the switching command is electromagnetic signals received by the communication module 114, the operation method of the gesture recognition device 11C includes following steps:

step S20, determining whether an initiation command is received by the communication module 114, if yes, proceeding to step S21, if no, repeating step S20;

step S21, determining whether a selecting command is received by the communication module 114, if yes, proceeding to step S22, if no, repeating step S21;

step S22, selecting one of the 2D recognizing module 1132 and the 3D recognizing module 1133 according to the selecting command as a selected recognizing module, proceeding to step S23;

step S23, obtaining the hand's positional data of a gesture, proceeding to step S24;

step S24, recognizing the gesture using the selected recognizing module, proceeding to step S25;

step S25, sending the gesture to the intelligent interaction device 12, proceeding to step S26;

step S26, determining whether an end command is received by the communication module 114 with in a first time threshold, if yes, return to step S20, if no, proceeding to step S27;

step S27, determining whether a switching command is received by the communication module 114 with in a second time threshold, if yes, proceeding to step S28, if no, return to step S23; and

step S28, switching the selected recognizing module between the 2D recognizing module 1132 and the 3D recognizing module 1133, return to step S23.

In step S26 and step S27, the first time threshold and the second time threshold can be selected according to need or experience. In one exemplary embodiment, the first time threshold is in a range of about 2 seconds to about 5 seconds, and the second time threshold is in a range of about 2 seconds to about 5 seconds.

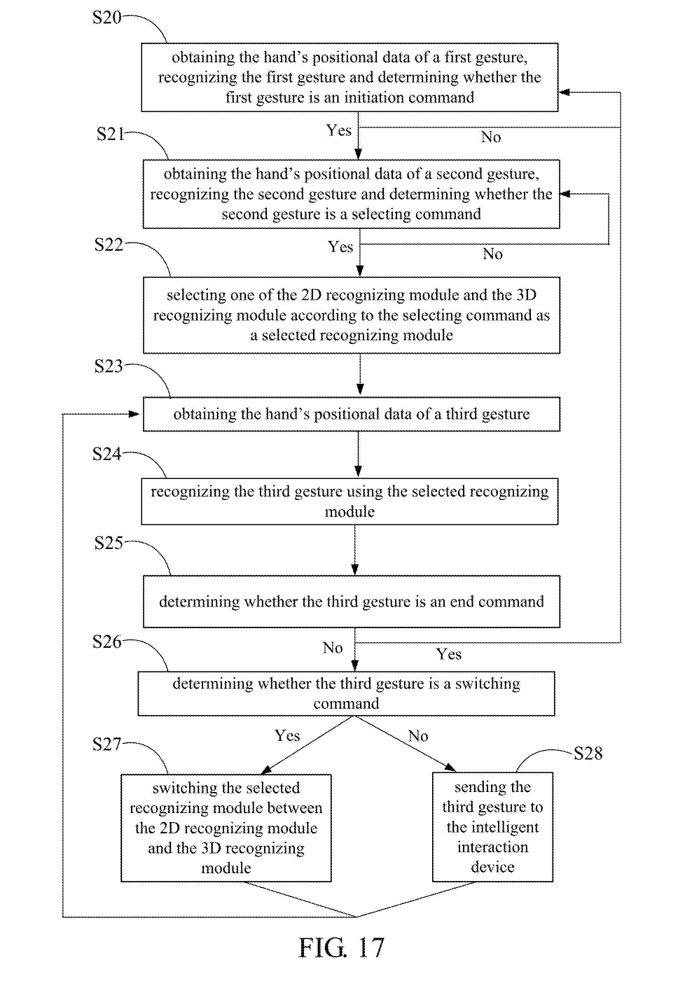

Referring to FIG. 17, in another exemplary embodiment, when the selecting command is a gesture performed by user and recognized by the recognizing module 113, the operation method of the gesture recognition device 11C includes following steps:

step S20, obtaining the hand's positional data of a first gesture, recognizing the first gesture and determining whether the first gesture is an initiation command, if yes, proceeding to step S21, if no, repeating step S20;

step S21, obtaining the hand's positional data of a second gesture, recognizing the second gesture and determining whether the second gesture is a selecting command, if yes, proceeding to step S22, if no, repeating step S21;

step S22, selecting one of the 2D recognizing module 1132 and the 3D recognizing module 1133 according to the selecting command as a selected recognizing module, proceeding to step S23;

step S23, obtaining the hand's positional data of a third gesture, proceeding to step S24;

step S24, recognizing the third gesture using the selected recognizing module, proceeding to step S25;

step S25, determining whether the third gesture is an end command, if yes, return to step S20, if no, proceeding to step S26;

step S26, determining whether the third gesture is a switching command, if yes, proceeding to step S27, if no, proceeding to step S28;

step S27, switching the selected recognizing module between the 2D recognizing module 1132 and the 3D recognizing module 1133, return to step S23; and

step S28, sending the third gesture to the intelligent interaction device 12, return to step S23.

In step S26, a fourth standard gesture is defined as the switching command. The third gesture is compared with a fourth standard gesture by the fourth determining module 118. When the third gesture is the same as the fourth standard gesture, the third gesture is determined to be the switching command.

It is to be understood that the above-described exemplary embodiments are intended to illustrate rather than limit the disclosure. Any elements described in accordance with any exemplary embodiments is understood that they can be used in addition or substituted in other exemplary embodiments. Exemplary embodiments can also be used together. Variations may be made to the exemplary embodiments without departing from the spirit of the disclosure. The above-described exemplary embodiments illustrate the scope of the disclosure but do not restrict the scope of the disclosure.

Depending on the exemplary embodiment, certain of the steps of methods described may be removed, others may be added, and the sequence of steps may be altered. It is also to be understood that the description and the claims drawn to a method may include some indication in reference to certain steps. However, the indication used is only to be viewed for identification purposes and not as a suggestion as to an order for the steps.

What is claimed is:

1. A gesture recognition device, comprising:
a controlling module;
a capturing module connected to the controlling module, wherein the capturing module comprises a 3-dimensional (3D) sensor for hand motion capture and obtains a positional data of a hand gesture by capturing positions of a hand;
a calculating module connected to the controlling module, wherein the calculating module calculates a distance between two positions of the hand according to the positional data of the hand gesture;
a recognizing module connected to the controlling module, wherein the recognizing module recognizes the hand gesture according to the positional data of the hand gesture; and
a communication module connected to the controlling module.

2. The gesture recognition device of claim 1, further comprising a first determining module, wherein the first determining module determines whether the hand gesture is a 2-dimensional (2D) hand gesture; and wherein the recognizing module comprises a 2D recognizing module and a 3D recognizing module.

3. The gesture recognition device of claim 2, wherein an operation method of the gesture recognition device comprises following steps:
step S11, obtaining the positional data of the hand gesture, then proceeding to step S12;
step S12, determining whether the hand gesture is a 2D hand gesture; wherein if yes, proceeding to step S13; and wherein if no, proceeding to step S14;
step S13, recognizing the hand gesture using the 2D recognizing module, then proceeding to step S15;
step S14, recognizing the hand gesture using the 3D recognizing module, then proceeding to step S15; and
step S15, sending the hand gesture, then return to step S11.

4. The gesture recognition device of claim 3, wherein determining whether the hand gesture is the 2D hand gesture comprises:
calculating a maximum distance of the hand gesture along a depth direction; and
determining whether the maximum distance is less than or equal to a distance threshold.

5. The gesture recognition device of claim 2, further comprising a second determining module; wherein the second determining module determines whether an initiation command or an end command is received by the communication module; and wherein an operation method of the gesture recognition device comprises following steps:
step S10, determining whether the initiation command is received by the communication module; wherein if yes, proceeding to step S11; and wherein if no, repeat step S10;
step S11, obtaining the positional data of the hand gesture, then proceeding to step S12;
step S12, determining whether the hand gesture is the 2D hand gesture; wherein if yes, proceeding to step S13; wherein if no, proceeding to step S14;
step S13, recognizing the hand gesture using the 2D recognizing module, then proceeding to step S15;
step S14, recognizing the hand gesture using the 3D recognizing module, then proceeding to step S15;
step S15, sending the hand gesture, proceeding to step S16; and
step S16, determining whether the end command is received by the communication module with in a time threshold; wherein if yes, return to step S10; wherein if no, return to step S11.

6. The gesture recognition device of claim 2, further comprising a second determining module and a third determining module; wherein the second determining module determines whether an initiation command or an end command is received by the communication module; wherein the third determining module determines whether a selecting command is received by the communication module; and wherein an operation method of the gesture recognition device comprises following steps:
step S20, determining whether the initiation command is received by the communication module; wherein if yes, proceeding to step S21; wherein if no, repeating step S20;
step S21, determining whether the selecting command is received by the communication module; wherein if yes, proceeding to step S22; wherein if no, repeating step S21;
step S22, selecting one of the 2D recognizing module and the 3D recognizing module according to the selecting command as the selected recognizing module, proceeding to step S23;
step S23, obtaining the positional data of the hand gesture, then proceeding to step S24;
step S24, recognizing the hand gesture using the selected recognizing module, then proceeding to step S25;
step S25, sending the hand gesture, proceeding to step S26; and
step S26, determining whether the end command is received by the communication module with in a time threshold; wherein if yes, return to step S20; wherein if no, return to step S23.

7. The gesture recognition device of claim 2, further comprising a second determining module, a third determining module, and a fourth determining module; wherein the second determining module determines whether an initiation command or an end command is received by the communication module; wherein the third determining module determines whether a selecting command is received by the communication module; wherein the fourth determining module determines whether a switching command is received by the communication module; and wherein an operation method of the gesture recognition device comprises following steps:
step S20, determining whether the initiation command is received by the communication module; wherein if yes, proceeding to step S21; wherein if no, repeating step S20;
step S21, determining whether the selecting command is received by the communication module; wherein if yes, proceeding to step S22; wherein if no, repeating step S21;
step S22, selecting one of the 2D recognizing module 1132 and the 3D recognizing module 1133 according to the selecting command as a selected recognizing module, then proceeding to step S23;
step S23, obtaining the positional data of the hand gesture, then proceeding to step S24;
step S24, recognizing the hand gesture using the selected recognizing module, proceeding to step S25;
step S25, sending the hand gesture, then proceeding to step S26;
step S26, determining whether the end command is received by the communication module with in a first time threshold; wherein if yes, return to step S20; wherein if no, proceeding to step S27;
step S27, determining whether the switching command is received by the communication module with in a second time threshold; wherein if yes, proceeding to step S28; wherein if no, return to step S23; and
step S28, switching the selected recognizing module between the 2D recognizing module and the 3D recognizing module, then return to step S23.

8. The gesture recognition device of claim 2, further comprising a second determining module; wherein the second determining module determines whether an initiation command or an end command is received by the recognizing module; and wherein an operation method of the gesture recognition device comprises following steps:
step S10, obtaining a first positional data of a first hand gesture, recognizing the first hand gesture and determining whether the first hand gesture is the initiation command; wherein if yes, proceeding to step S11; wherein if no, repeating step S10;
step S11, obtaining a second positional data of a second hand gesture, then proceeding to step S12;
step S12, determining whether the second hand gesture is the 2D hand gesture; wherein if yes, proceeding to step S13; wherein if no, proceeding to step S14;
step S13, recognizing the second hand gesture using the 2D recognizing module, then proceeding to step S15;
step S14, recognizing the second hand gesture using the 3D recognizing module, then proceeding to step S15;
step S15, determining whether the second hand gesture is the end command; wherein if yes, return to step S10; wherein if no, proceeding to step S16; and
step S16, sending the second hand gesture, then return to step S11.

9. The gesture recognition device of claim 2, further comprising a second determining module and a third determining module; wherein the second determining module determines whether an initiation command or an end command is received by the recognizing module; wherein the third determining module determines whether a selecting command is received by the recognizing module; and wherein an operation method of the gesture recognition device comprises following steps:
step S20, obtaining a first positional data of a first hand gesture, recognizing the first hand gesture and determining whether the first hand gesture is the initiation command; wherein if yes, proceeding to step S21; wherein if no, repeating step S20;
step S21, obtaining a second positional data of a second hand gesture, recognizing the second hand gesture and determining whether the second hand gesture is the selecting command; wherein if yes, proceeding to step S22; wherein if no, repeating step S21;
step S22, selecting one of the 2D recognizing module and the 3D recognizing module according to the selecting command as a selected recognizing module, then proceeding to step S23;
step S23, obtaining a third positional data of a third hand gesture, then proceeding to step S24;
step S24, recognizing the third hand gesture using the selected recognizing module, then proceeding to step S25;
step S25, determining whether the third hand gesture is the end command; wherein if yes, return to step S20; wherein if no, proceeding to step S26; and
step S26, sending the third hand gesture, then return to step S23.

10. The gesture recognition device of claim 2, further comprising a second determining module, a third determining module, and a fourth determining module; wherein the second determining module determines whether an initiation command or an end command is received by the recognizing module; wherein the third determining module determines whether a selecting command is received by the recognizing module; wherein the fourth determining module determines whether a switching command is received by the recognizing module; and wherein an operation method of the gesture recognition device comprises following steps:
step S20, obtaining a first positional data of a first hand gesture, recognizing the first hand gesture and determining whether the first hand gesture is the initiation command; wherein if yes, proceeding to step S21; wherein if no, repeating step S20;
step S21, obtaining a second positional data of second hand gesture, recognizing the second hand gesture and determining whether the second hand gesture is the selecting command; wherein if yes, proceeding to step S22; wherein if no, repeating step S21;
step S22, selecting one of the 2D recognizing module and the 3D recognizing module according to the selecting command as a selected recognizing module, then proceeding to step S23;
step S23, obtaining a third positional data of a third hand gesture, then proceeding to step S24;
step S24, recognizing the third hand gesture using the selected recognizing module, then proceeding to step S25;
step S25, determining whether the third hand gesture is the end command; wherein if yes, return to step S20; wherein if no, proceeding to step S26;
step S26, determining whether the third hand gesture is the switching command; wherein if yes, proceeding to step S27; wherein if no, proceeding to step S28;
step S27, switching the selected recognizing module between the 2D recognizing module and the 3D recognizing module, then return to step S23; and
step S28, sending the third hand gesture, then return to step S23.

11. A man-machine interaction system comprising: a gesture recognition device and an intelligent interaction device connected to the gesture recognition device; wherein the gesture recognition device comprises:
a controlling module;
a capturing module connected to the controlling module, wherein the capturing module comprises a 3-dimensional (3D) sensor for hand motion capture and obtains a positional data of a hand gesture by capturing positions of a hand;
a calculating module connected to the controlling module, wherein the calculating module calculates a distance between two positions of the hand according to the positional data of the hand gesture;
a recognizing module connected to the controlling module, wherein the recognizing module recognizes the hand gesture according to the positional data of the hand gesture; and
a communication module connected to the controlling module.

12. The man-machine interaction system of claim 11, wherein the gesture recognition device further comprises a first determining module, wherein the first determining module determines whether the hand gesture is a 2-dimensional (2D) hand gesture; and wherein the recognizing module comprises a 2D recognizing module and a 3D recognizing module.

13. The man-machine interaction system of claim 12, wherein an operation method of the gesture recognition device comprises following steps:
step S11, obtaining the positional data of the hand gesture, then proceeding to step S12;
step S12, determining whether the hand gesture is a 2D hand gesture; wherein if yes, proceeding to step S13; and wherein if no, proceeding to step S14;
step S13, recognizing the hand gesture using the 2D recognizing module, then proceeding to step S15;
step S14, recognizing the hand gesture using the 3D recognizing module, then proceeding to step S15; and
step S15, sending the hand gesture, then return to step S11.

14. The man-machine interaction system of claim 13, wherein determining whether the hand gesture is the 2D hand gesture comprises:
calculating a maximum distance of the hand gesture along a depth direction; and
determining whether the maximum distance is less than or equal to a distance threshold.

15. The man-machine interaction system of claim 12, wherein the gesture recognition device further comprises a second determining module; wherein the second determining module determines whether an initiation command or an end command is received by the communication module; and wherein an operation method of the gesture recognition device comprises following steps:
step S10, determining whether the initiation command is received by the communication module; wherein if yes, proceeding to step S11; and wherein if no, repeat step S10;
step S11, obtaining the positional data of the hand gesture, then proceeding to step S12;
step S12, determining whether the hand gesture is the 2D hand gesture; wherein if yes, proceeding to step S13; wherein if no, proceeding to step S14;
step S13, recognizing the hand gesture using the 2D recognizing module, then proceeding to step S15;
step S14, recognizing the hand gesture using the 3D recognizing module, then proceeding to step S15;
step S15, sending the hand gesture, proceeding to step S16; and
step S16, determining whether the end command is received by the communication module with in a time threshold; wherein if yes, return to step S10; wherein if no, return to step S11.

16. The man-machine interaction system of claim 12, wherein the gesture recognition device further comprises a second determining module and a third determining module; wherein the second determining module determines whether an initiation command or an end command is received by the communication module; wherein the third determining module determines whether a selecting command is received by the communication module; and wherein an operation method of the gesture recognition device comprises following steps:
step S20, determining whether the initiation command is received by the communication module; wherein if yes, proceeding to step S21; wherein if no, repeating step S20;
step S21, determining whether the selecting command is received by the communication module; wherein if yes, proceeding to step S22; wherein if no, repeating step S21;
step S22, selecting one of the 2D recognizing module and the 3D recognizing module according to the selecting command as the selected recognizing module, proceeding to step S23;
step S23, obtaining the positional data of the hand gesture, then proceeding to step S24;
step S24, recognizing the hand gesture using the selected recognizing module, then proceeding to step S25;
step S25, sending the hand gesture, proceeding to step S26; and
step S26, determining whether the end command is received by the communication module with in a time threshold; wherein if yes, return to step S20; wherein if no, return to step S23.

17. The man-machine interaction system of claim 12, wherein the gesture recognition device further comprises a second determining module, a third determining module, and a fourth determining module; wherein the second determining module determines whether an initiation command or an end command is received by the communication module; wherein the third determining module determines whether a selecting command is received by the communication module; wherein the fourth determining module determines whether a switching command is received by the communication module; and wherein an operation method of the gesture recognition device comprises following steps:
step S20, determining whether the initiation command is received by the communication module; wherein if yes, proceeding to step S21; wherein if no, repeating step S20;
step S21, determining whether the selecting command is received by the communication module; wherein if yes, proceeding to step S22; wherein if no, repeating step S21;
step S22, selecting one of the 2D recognizing module 1132 and the 3D recognizing module 1133 according to the selecting command as a selected recognizing module, then proceeding to step S23;
step S23, obtaining the positional data of the hand gesture, then proceeding to step S24;
step S24, recognizing the hand gesture using the selected recognizing module, proceeding to step S25;
step S25, sending the hand gesture, then proceeding to step S26;
step S26, determining whether the end command is received by the communication module with in a first time threshold; wherein if yes, return to step S20; wherein if no, proceeding to step S27;
step S27, determining whether the switching command is received by the communication module with in a second time threshold; wherein if yes, proceeding to step S28; wherein if no, return to step S23; and
step S28, switching the selected recognizing module between the 2D recognizing module and the 3D recognizing module, then return to step S23.

18. The man-machine interaction system of claim 12, wherein the gesture recognition device further comprises a second determining module; wherein the second determining module determines whether an initiation command or an end command is received by the recognizing module; and wherein an operation method of the gesture recognition device comprises following steps:
step S10, obtaining a first positional data of a first hand gesture, recognizing the first hand gesture and determining whether the first hand gesture is the initiation command; wherein if yes, proceeding to step S11; wherein if no, repeating step S10;
step S11, obtaining a second positional data of a second hand gesture, then proceeding to step S12;
step S12, determining whether the second hand gesture is the 2D hand gesture; wherein if yes, proceeding to step S13; wherein if no, proceeding to step S14;
step S13, recognizing the second hand gesture using the 2D recognizing module, then proceeding to step S15;
step S14, recognizing the second hand gesture using the 3D recognizing module, then proceeding to step S15;
step S15, determining whether the second hand gesture is the end command; wherein if yes, return to step S10; wherein if no, proceeding to step S16; and
step S16, sending the second hand gesture, then return to step S11.

19. The man-machine interaction system of claim 12, wherein the gesture recognition device further comprises a second determining module and a third determining module; wherein the second determining module determines whether an initiation command or an end command is received by the recognizing module; wherein the third determining module determines whether a selecting command is received by the recognizing module; and wherein an operation method of the gesture recognition device comprises following steps:
step S20, obtaining a first positional data of a first hand gesture, recognizing the first hand gesture and determining whether the first hand gesture is the initiation command; wherein if yes, proceeding to step S21; wherein if no, repeating step S20;
step S21, obtaining a second positional data of a second hand gesture, recognizing the second hand gesture and determining whether the second hand gesture is the selecting command; wherein if yes, proceeding to step S22; wherein if no, repeating step S21;
step S22, selecting one of the 2D recognizing module and the 3D recognizing module according to the selecting command as a selected recognizing module, then proceeding to step S23;
step S23, obtaining a third positional data of a third hand gesture, then proceeding to step S24;
step S24, recognizing the third hand gesture using the selected recognizing module, then proceeding to step S25;
step S25, determining whether the third hand gesture is the end command; wherein if yes, return to step S20; wherein if no, proceeding to step S26; and
step S26, sending the third hand gesture, then return to step S23.

20. The man-machine interaction system of claim 12, wherein the gesture recognition device further comprises a second determining module, a third determining module, and a fourth determining module; wherein the second determining module determines whether an initiation command or an end command is received by the recognizing module; wherein the third determining module determines whether a selecting command is received by the recognizing module; wherein the fourth determining module determines whether a switching command is received by the recognizing module; and wherein an operation method of the gesture recognition device comprises following steps:
step S20, obtaining a first positional data of a first hand gesture, recognizing the first hand gesture and determining whether the first hand gesture is the initiation command; wherein if yes, proceeding to step S21; wherein if no, repeating step S20;
step S21, obtaining a second positional data of a second hand gesture, recognizing the second hand gesture and determining whether the second hand gesture is the selecting command; wherein if yes, proceeding to step S22; wherein if no, repeating step S21;
step S22, selecting one of the 2D recognizing module and the 3D recognizing module according to the selecting command as a selected recognizing module, then proceeding to step S23;
step S23, obtaining a third positional data of a third hand gesture, then proceeding to step S24;
step S24, recognizing the third hand gesture using the selected recognizing module, then proceeding to step S25;
step S25, determining whether the third hand gesture is the end command; wherein if yes, return to step S20; wherein if no, proceeding to step S26;
step S26, determining whether the third hand gesture is the switching command; wherein if yes, proceeding to step S27; wherein if no, proceeding to step S28;
step S27, switching the selected recognizing module between the 2D recognizing module and the 3D recognizing module, then return to step S23; and
step S28, sending the third hand gesture, then return to step S23.
